(19) United States
(12) Patent Application Publication
(10) Pub. No.: US 2023/0344076 A1
(43) Pub. Date: Oct. 26, 2023

(54) Battery Cell Thermal Runaway Fume Treatment Device, Battery Cell Shell, Battery Cell Box, and Battery

(71) Applicant: Australia National Power Storage Holding Pty Ltd, Chatswood (AU)

(72) Inventors: Sanxue ZHANG, Xi'an (CN); Zhengjun LEI, Xi'an (CN); Xiaoyu HAN, Xi'an (CN); Yu LI, Xi'an (CN)

(73) Assignee: Australia National Power Storage Holding Pty Ltd, Chatswood (AU)

(21) Appl. No.: 18/307,170

(22) Filed: Apr. 26, 2023

Related U.S. Application Data
(60) Provisional application No. 63/334,821, filed on Apr. 26, 2022.

(51) Int. Cl. H01M 50/383; H01M 10/0525; H01M 50/342

(52) U.S. Cl. CPC H01M 50/383; H01M 10/0525; H01M 50/3425

(57) ABSTRACT

Disclosed are a Li-ion battery and a Li-ion battery pack, each of which comprises: at least one battery cell; an explosion-venting mechanism fixed to the battery cell for releasing thermal runaway fume generated by the battery cell in the case of thermal runaway; a manifold fixedly connected to the explosion-venting mechanism for transferring the thermal runaway fume; and an ignition device fixedly connected to the manifold to ignite the thermal runaway fume transferred from the manifold. In the Li-ion battery cell and battery provided by the present application, an explosion-venting mechanism and a manifold are arranged on the battery cell shells, the thermal runaway fume generated by a battery cell during thermal runaway is released directionally and discharged through the manifold; in addition, an ignition device is provided to ignite the thermal runaway fume for combustion.

### CROSS-REFERENCE TO RELATED APPLICATIONS

This application claims priority to U.S. Provisional Application No. 63/334,821, filed on Apr. 26, 2022, the subject matter of which is hereby incorporated by reference in its entirety.

### TECHNICAL FIELD

The present application relates to the technical field of battery cells, in particular to a battery cell thermal runaway fume treatment device, a battery cell shell, and a battery.

### BACKGROUND

Li-ion battery cells are widely applied. In recent years, as the Li-ion battery energy storage field is further developed, more and more attentions are paid to the safe use of Li-ion battery cells. A Li-ion battery cell may generate a flammable gas during thermal runaway, which is accumulated inside the battery cell, and may cause fire if it is not treated timely. At present, there is no solution to the above problem in the power storage battery field yet.

Chinese Patent Publication No. CN208400933U discloses a combined-type power battery cell thermal runaway protection device, which comprises: an outer frame, a heat-insulating and flame-retardant material, a module base plate and a plurality of cover plates; wherein the module base plate and the cover plates are mounted at two ends of the outer frame respectively and form a flame-retardant cavity in which battery modules are arranged, and the cover plates cover corresponding battery modules in a battery box respectively; the heat-insulating and flame-retardant material is arranged above the inner wall of the flame-retardant cavity, and is released in the flame-retardant cavity and acts on the battery modules. The utility model can control the fire-extinguishing process of each battery module separately, thereby protecting against thermal runaway at the level of battery modules, and avoiding thermal runaway of the battery modules.

Chinese Patent Publication No. CN208806333U discloses a Li-ion battery, which comprises: a plurality of battery cells; a first filtering device connected to the battery cells for filtering the inflammable gases released by the battery cells in the case of thermal runaway; a combustion chamber; an air pumping device connected to the combustion chamber for feeding air into the combustion chamber, so that the air is mixed with the inflammable gases to form a gas mixture; a second unidirectional gas transfer device connected between the first filtering device and the combustion chamber, wherein the inflammable gas passes through the first filtering device and the second unidirectional gas transfer device sequentially and enters the combustion chamber; and a control device electrically connected to the second unidirectional gas transfer device and the air pumping device respectively. The Li-ion battery can avoid emission of the inflammable gas into the external environment, which may cause environmental pollution and fire. The inflammable gas released from a battery cell can be isolated from the plurality of battery cells rapidly, to ensure the safety of the Li-ion battery.

However, the technical scheme provided by the above-mentioned patent to solve the battery cell thermal runaway problem employs a complex structure, has low efficiency, low safety and high cost.

### SUMMARY

To solve the above problems, a technical scheme employed by the present application provides a Li-ion battery, which comprises:
at least one battery cell;
an explosion-venting mechanism fixed to the battery cell for releasing thermal runaway fume generated by the battery cell in the case of thermal runaway;
a manifold fixedly connected to the explosion-venting mechanism for transferring the thermal runaway fume; and
an ignition device fixedly connected to the manifold to ignite the thermal runaway fume transferred from the manifold.

A technical scheme employed by the present application provides a Li-ion battery pack, which comprises: a box, inside which a plurality of Li-ion battery cells are arranged;
an explosion-venting mechanism fixed to the box for releasing thermal runaway fume generated by the battery cells in the case of thermal runaway;
a manifold fixedly connected to the explosion-venting mechanism for transferring the thermal runaway fume; and
an ignition device fixedly connected to the manifold to ignite the thermal runaway fume transferred from the manifold.

Based on the above technical schemes of the Li-ion battery and the Li-ion battery pack, the following optimization design can be worked out:

Preferably, the manifold is further provided with a backfire preventer fixed thereon.

Preferably, the Li-ion battery cell further comprises a buffer device arranged in front of the ignition device; and the buffer mechanism is further provided with a pressure-relief valve.

Preferably, the buffer mechanism is an elastic bag or pressure container.

Preferably, the ignition device is a pulse igniter; and the ignition device further comprises an air inlet for introducing air to mix with the thermal runaway fume for ignition.

A technical scheme employed by the present application provides a battery cell thermal runaway fume treatment device, which comprises a gas storage chamber and an ignition device, wherein
the gas storage chamber comprises a gas inlet and a gas outlet for introducing the thermal runaway fume into the gas storage chamber and discharging the thermal runaway fume out of the gas storage chamber;
the ignition device is fixedly arranged outside the gas storage chamber at the gas outlet;
the gas storage chamber is partitioned by a movable partition into a first compartment and a second compartment that are separated from each other;
the gas inlet is arranged inside the first compartment, and the gas outlet is arranged inside the second compartment;
the second compartment is further provided with a switch assembly therein, which comprises an ignition switch; and
when the gas pressure in the first compartment increases, the movable partition is pushed by the gas pressure in the first compartment to abut against the ignition switch, so that the ignition device is switched on and the gas outlet is at least partially exposed to the first compartment to discharge the thermal runaway fume.

Preferably, the first compartment and/or the second compartment are(is) provided with an elastic assembly, which abuts between the first compartment and/or the second compartment and the movable partition.

Preferably, the movable partition is provided with sealing gaskets to maintain the gas impermeability of the first compartment and the second compartment.

Preferably, the gas outlet is configured as a duct, on which a flow check valve is provided to control the flow rate of the thermal runaway fume.

Preferably, the gas storage chamber comprises a mounting part for fixedly mounting on the battery cells.

Preferably, the ignition device is a pulse igniter.

Preferably, the gas storage chamber is a cylinder, the movable partition comprises a base and a protrusion, wherein the protrusion can be inserted into the gas inlet to maintain the gas inlet in a hermetical state at normal temperature, the base is movable along the cylinder axially, and there is a gap between the base and the cylinder for the thermal runaway fume to pass through; the base is further provided with the switch assembly, the protrusion is jacked up and the switch assembly is abutted when the thermal runaway fume passes through the gas inlet owing to pressure increase, so that the ignition device is switched on and the thermal runaway fume is ignited.

A technical scheme employed by the present application provides a battery cell shell, comprises any of the battery cell thermal runaway fume treatment devices described above.

Preferably, the shell further comprises a manifold, one end of which is connected to an explosion vent of the battery cell shell, and the other end of which is fixedly connected to the mounting part of the thermal runaway fume treatment device.

A technical scheme employed by the present application provides a battery cell thermal runaway fume treatment device, which comprises a venting cylinder, a plurality of venting nozzles, pressure valves, ignition switches, and ignition devices, wherein
the venting nozzles are fixedly connected to the venting cylinder respectively to form thermal runaway fume venting passages;
the pressure valves and the ignition switches are arranged inside corresponding venting passages, each of the pressure valves comprises a piston, and seals the corresponding venting passage at normal pressure to keep the venting passage closed; at a high pressure, the piston inside the pressure valve is pushed by the gas pressure to move, so that the venting passage is opened, and the pressure valve abuts against the ignition switch to switch on the ignition device at the same time; and
when a battery cell generates thermal runaway fume, the pistons in the pressure valves are pushed in turn as the gas pressure increases gradually, the ignition switches are actuated sequentially and switch on the ignition devices, so that the thermal runaway fume is ignited.

Preferably, the venting cylinder is further provided with an anti-backfire valve.

Preferably, the pressure valve is provided with a sealing gasket.

Preferably, the venting cylinder and the venting nozzles are fixedly arranged on the fixing cylinders respectively to form gas passages, so that the thermal runaway fume can pass through the venting cylinder, the fixing cylinders, and the venting nozzles sequentially.

Preferably, the pressure valve is fixedly arranged at a joint between the fixing cylinder and the venting nozzle, the pressure valve is provided with a protrusion, the ignition switch is arranged inside the venting nozzle; when the piston of the pressure valve is moved, the protrusion abuts against the ignition switch, so that the ignition device is switched on.

Preferably, the ignition device is a pulse igniter.

Preferably, the fume treatment device further comprises a mounting part to mount on the battery cell shell.

A technical scheme employed by the present application provides a battery cell shell, comprises any of the battery cell thermal runaway fume treatment devices described above.

Preferably, the shell further comprises a manifold, one end of which is connected to an explosion vent of the battery cell shell, and the other end of which is fixedly connected to the mounting part of the thermal runaway fume treatment device.

A technical scheme employed by the present application provides a battery cell thermal runaway gas treatment device, which comprises a gas storage chamber, wherein
the gas storage chamber is provided with a sealing partition therein to separate the gas storage chamber into an enclosed first compartment and an enclosed second compartment;
the first compartment comprises a gas inlet duct for the thermal runaway gas to enter the first compartment;
the second compartment comprises a venting duct to discharge the thermal runaway gas, and the ignition device is arranged at an outlet of the venting duct;
the partition is provided with a pressure-relief valve, and the thermal runaway gas can pass through the pressure-relief valve and enter the second compartment from the first compartment;
the gas storage chamber is further provided with a switch assembly, which comprises a trigger and an ignition switch, wherein the trigger is inserted through the partition and can be pushed by the gas pressure, and the ignition switch is arranged inside the second compartment and can be actuated by the trigger;
when the gas pressure in the first compartment reaches a first threshold P₁, the thermal runaway gas enters the second compartment through the pressure-relief valve, and reaches the outlet through the venting duct;
when the gas pressure in the first compartment reaches a second threshold P₂, the trigger abuts against the ignition switch, so that the ignition switch is actuated and switches on the ignition device, and the thermal runaway gas is ignited; and
the value of the first threshold P₁ is not smaller than the value of the second threshold P₂.

Preferably, the partition is provided with sealing gaskets to maintain the gas impermeability of the first compartment and the second compartment.

Preferably, the gas outlet duct is provided with a flow check valve to control the flow rate of the thermal runaway fume.

Preferably, the ignition device is a pulse igniter.

Preferably, the gas outlet is provided with at least two venting nozzles, and the ignition device comprises at least two ignition ports.

Preferably, the gas storage chamber is provided with a supporting base outside it for mounting the ignition device.

A technical scheme employed by the present application provides a battery cell shell, which comprises an explosion vent thereon and any of the battery cell thermal runaway fume treatment devices described above, wherein the gas inlet of the cell battery cell thermal cell runaway fume treatment device is provided with a mounting part for fixedly mounting to the explosion vent.

A technical scheme employed by the present application provides a battery cell, which comprises the battery cell shell described above.

A technical scheme employed by the present application provides a battery, which comprises a plurality of battery cells described above, and further comprises a manifold, one end of which comprises a plurality of branch ducts connected to the explosion vents in one-to-one correspondence, and the other end of which fixedly connected to the mounting part of the thermal runaway fume treatment device.

The present application has the following beneficial effects.

A thermal runaway fume treatment device is provided on the battery cell to release the fume generated by the battery cell during thermal runaway through a venting cylinder and a plurality of venting nozzles, a plurality of pressure valves and ignition switches are provided in gas passages formed by the venting cylinder and the venting nozzles, and the ignition devices are switched sequentially on by means of the pressure valves abutting against the ignition switches via the venting nozzles when the gas pressure of the thermal runaway fume reaches a threshold, so that the thermal runaway fume is ignited. The device has a simple and compact structure, and can treat the fume generated by a battery cell during thermal runaway. The device is safe and environment-friendly, economical and practical, and highly efficient.

### BRIEF DESCRIPTION OF THE DRAWINGS

FIG. 1 is a schematic diagram of the Li-ion battery in Embodiment 1.

FIG. 2 is a schematic diagram of the pulse igniter in Embodiment 1.

FIG. 3 is a schematic diagram of Embodiment 2.

FIG. 4 is a schematic diagram of Embodiment 3.

FIG. 5 is a schematic diagram of the Li-ion battery pack in Embodiment 4.

FIG. 6 is a schematic diagram of Embodiment 5.

FIG. 7 is a schematic diagram of Embodiment 6.

FIG. 8 is a schematic structural diagram of Embodiment 7 when viewed from a first viewing angle.

FIG. 9 is a schematic structural diagram of Embodiment 7 when viewed from a second viewing angle.

FIG. 10 is a schematic structural diagram of embodiment 8.

FIG. 11 is a schematic structural diagram of Embodiment 9.

FIG. 12 is a schematic structural diagram of Embodiment 9 when viewed from a first viewing angle.

FIG. 13 is a schematic structural diagram of Embodiment 9 when viewed from a second viewing angle.

FIG. 14 is a schematic structural diagram of Embodiment 10.

FIG. 15 is a schematic structural diagram of Embodiment 11.

FIG. 16 is a sectional view of the structure of Embodiment 11.

FIG. 17 is an exploded view of the structure of Embodiment 11.

FIG. 18 is a schematic structural diagram of Embodiment 12.

FIG. 19 is a sectional view of the structure of Embodiment 12.

FIG. 20 is a schematic structural diagram of Embodiment 14 in a first state.

FIG. 21 is a schematic structural diagram of Embodiment 14 in a second state.

FIG. 22 is a schematic structural diagram of Embodiment 17.

### DETAILED DESCRIPTION OF THE EMBODIMENTS

To make the objects, technical scheme and advantages of the present application understood more clearly, hereunder the present application will be further detailed in embodiments, with reference to the accompanying drawings. It should be understood that the embodiments described hereunder are only provided to interpret the present application but don't constitute any limitation to the present application.

Unless otherwise specified, all embodiments and optional embodiments of the present application can be combined to form new technical schemes. Unless otherwise specified, all technical features and optional technical features of the present application can be combined to form new technical schemes.

Unless otherwise specified, terms “comprise” and “include” and their variants mentioned in the present application are intended to be open or close expressions. For example, “comprise” and “include” may express further including other elements that are not enumerated herein, or only including the enumerated elements.

It should be understood that the relational terms such as “first”, “second” or the like mentioned herein are only intended to distinguish one entity or operation from another entity or operation, without necessarily requiring or implying any such actual relationship or sequence between these entities or operations.

### Embodiment 1

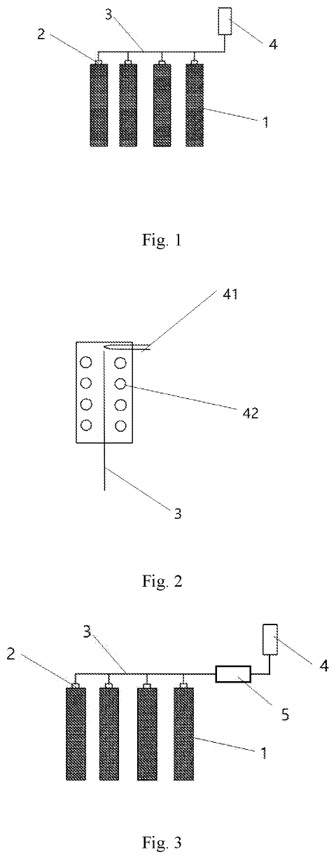

As shown in FIG. 1, the present application provides a Li-ion battery, which comprises at least one battery cell 1; an explosion-venting mechanism 2 fixed to the battery cell 1 for releasing thermal runaway fume generated by the battery cell in the case of thermal runaway; a manifold 3 with one end fixedly connected to the explosion-venting mechanism 2 for transferring the thermal runaway fume; and an ignition device 4 fixedly connected to the other end of the manifold 3 for igniting the thermal runaway fume transferred through the manifold 3. The ignition device 4 is a pulse igniter. The ignition device 4 further comprises an air inlet for introducing air to mix with the thermal runaway fume. In the case that there is more than one battery cell, the manifold 3 is connected with the battery cells in parallel.

In this embodiment, a plurality of battery cells 1 may be arranged side by side to form a Li-ion battery, and the ignition device 4 may be arranged away from the battery cells 1, to prevent damages to the battery cells 1 caused by the combustion of the thermal runaway fume during the ignition.

The thermal runaway fume generated during the thermal runaway of a battery cell includes inflammable gases, including, but not limited to hydrogen, carbon monoxide, and methane, etc. Therefore, the manifold 3 is made of a high-temperature-resistant, high-pressure-resistant, and corrosion-resistant material.

The gas outlet of the explosion-venting mechanism 2 may be oriented in a way that the thermal runaway fume can be transferred only from the interior of the battery cell 1 to the manifold 3 but can't be transferred from the manifold 3 to the battery cell 1. The explosion-venting mechanism 2 will be exploded directionally when the thermal runaway fume generated by the battery cell 1 reaches a certain threshold. Each battery cell is provided with an explosion-venting mechanism 2. When any of the battery cells generates thermal runaway fume owing to thermal runaway, the thermal runaway fume is directed to the manifold 3 through the explosion-venting mechanism 2, while other battery cells 1 still operate normally.

FIG. 2 shows the ignition device 4 in this embodiment. In this embodiment, the ignition device 4 comprises an ignitor 41 and an air inlet 42. When the thermal runaway fume is transferred from the manifold 3 to the ignition device 4, the thermal runaway fume is spurted out, while air enters the ignition device 4 through the gas inlet and is mixed with the thermal runaway fume, the ignitor ignites the mixture of the thermal runaway fume and the air, making the thermal runaway fume harmless. The treatment is convenient, simple and efficient, and can avoid fire or pollution of the environment.

The ignitor 41 may be a pulse igniter, or an electric ignitor controlled by a battery cell management system.

### Embodiment 2

As shown in FIG. 3, the scheme of this embodiment is essentially the same as that of the embodiment 1, except for the following difference: this embodiment is based on the embodiment 1, and a backfire preventer 5 is fixedly provided on the manifold 3 to prevent the burning thermal runaway fume from entering the manifold 3 in the reversed direction after the thermal runaway fume is ignited.

### Embodiment 3

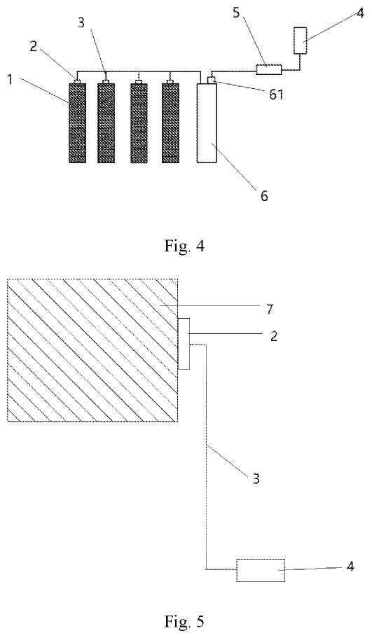

As shown in FIG. 4, the scheme of this embodiment is essentially the same as that of the embodiment 2, except for the following difference: this embodiment is based on the embodiment 2, and a buffer device 6 is further fixedly arranged in front of the backfire preventer 5. The buffer device further comprises a pressure-relief valve, the actuation pressure of the pressure-relief valve is lower than that of the explosion venting valve of the battery cell; when the thermal runaway fume is accumulated in the buffer device 6 through the manifold 3 and reaches certain pressure, the pressure-relief valve is opened, and the thermal runaway fume reaches the ignition device 4 through the pressure-relief valve.

In this embodiment, the buffer device 6 is an elastic bag or pressure container, which can withstand certain pressure to avoid failure of ignition of the thermal runaway fume at the ignition device 4 owing to extreme low concentration of the thermal runaway fume.

### Embodiment 4

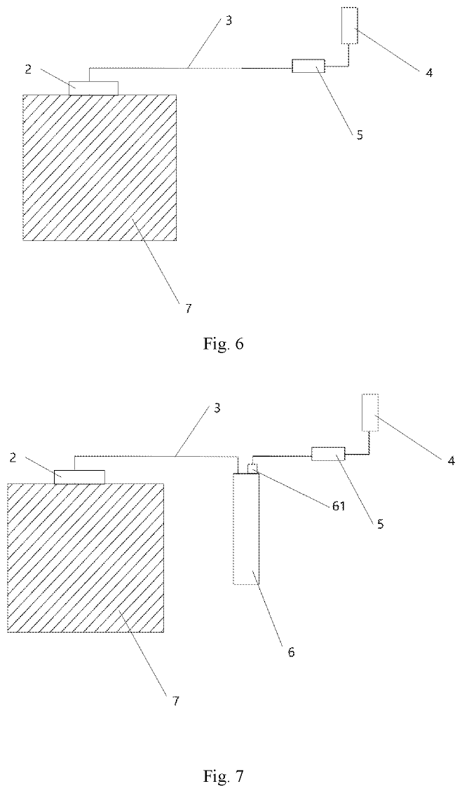

As shown in FIG. 5, the present application provides a Li-ion battery pack, which comprises a box 7 and a plurality of Li-ion battery cells connected in series or in shunt in the box 7; and an explosion-venting mechanism 2, which may be a pressure valve or communication tube and fixed to the box 7 for releasing the thermal runaway fume generated by the battery cell during thermal runaway; a manifold 3 with one end fixedly connected to the explosion-venting mechanism 2 for transferring the thermal runaway fume; and an ignition device 4 fixedly connected to the other end of the manifold 3 for igniting the thermal runaway fume transferred through the manifold 3. The ignition device 4 is a pulse igniter. The ignition device 4 further comprises an air inlet for introducing air to mix with the thermal runaway fume.

In this embodiment, the ignition device 4 may be arranged away from the box 7, to avoid damages to the battery cell owing to the combustion of the thermal runaway fume during the ignition.

The thermal runaway fume generated during the thermal runaway of a battery cell includes inflammable gases, including, but not limited to hydrogen, carbon monoxide, and methane, etc. Therefore, the manifold 3 is made of a high-temperature-resistant, high-pressure-resistant, and corrosion-resistant material.

The gas outlet of the explosion-venting mechanism 2 may be oriented in a way that the thermal runaway fume can be transferred only from the interior of the box 7 to the manifold 3 but can't be transferred from the manifold 3 to the box 7. The explosion-venting mechanism 2 will be exploded directionally when the thermal runaway fume generated in the box 7 reaches a certain threshold.

FIG. 2 shows the ignition device 4 in this embodiment. In this embodiment, the ignition device 4 comprises an ignitor and an air inlet. When the thermal runaway fume is transferred from the manifold 3 to the ignition device 4, the thermal runaway fume is spurted out, while air enters the ignition device 4 through the gas inlet and is mixed with the thermal runaway fume, the ignitor ignites the mixture of the thermal runaway fume and the air, making the thermal runaway fume harmless. The treatment is convenient, simple and efficient, and can avoid fire or pollution of the environment.

The ignitor may be a pulse igniter, or an electric ignitor controlled by a battery cell management system.

### Embodiment 5

As shown in FIG. 6, the scheme of this embodiment is essentially the same as that of the embodiment 4, except for the following difference: this embodiment is based on the embodiment 4, and a backfire preventer 5 is fixedly provided on the manifold 3 to prevent the burning thermal runaway fume from entering the manifold 3 in the reversed direction after the thermal runaway fume is ignited.

### Embodiment 6

As shown in FIG. 7, the scheme of this embodiment is essentially the same as that of the embodiment 5, except for the following difference: this embodiment is based on the embodiment 5, and a buffer device 6 is further fixedly arranged in front of the backfire preventer 5. The buffer device further comprises a pressure-relief valve, the actuation pressure of the pressure-relief valve is lower than that of the explosion venting valve of the battery cell; when the thermal runaway fume is accumulated in the buffer device 6 through the manifold 3 and reaches certain pressure, the pressure-relief valve is opened, and the thermal runaway fume reaches the ignition device 4 through the pressure-relief valve.

In this embodiment, the buffer device 6 is an elastic bag or pressure container, which can withstand certain pressure to avoid failure of ignition of the thermal runaway fume at the ignition device 4 owing to extreme low concentration of the thermal runaway fume.

### Embodiment 7

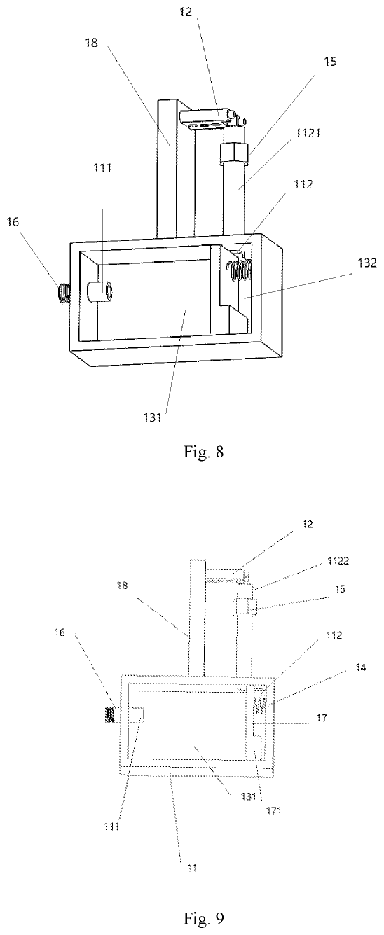

As shown in FIGS. 8-9, a battery cell thermal runaway fume treatment device is provided, comprising a gas storage chamber 11 and an ignition device 12, wherein the gas storage chamber 11 comprises a gas inlet 111 and a gas outlet 112 to introduce the thermal runaway fume into the gas storage chamber 11 and discharge the thermal runaway fume from the gas storage chamber 11; the ignition device 12 is fixedly arranged outside the gas storage chamber 11 at the gas outlet 112; in this embodiment, the gas storage chamber 11 is a rectangular box.

The gas storage chamber 11 is partitioned by a movable partition 17 into a first compartment 131 and a second compartment 132 that are separated from each other; the gas inlet 111 is arranged inside the first compartment 131, and the gas outlet 112 is arranged inside the second compartment 132.

An ignition switch 121 is provided inside the second compartment 132; when the gas pressure in the first compartment 131 increases, the movable partition 17 is pushed by the gas pressure in the first compartment 131 and touches the ignition switch 121, so that the ignition device 12 is switched on, and the gas outlet 112 is at least partially expose to the first compartment 131 to discharge the thermal runaway fume.

The second compartment 132 is provided with an elastic assembly 141 fixedly arranged on the movable partition 17 for restricting the movable partition 17 from actuated at a lower gas pressure. The movable partition 17 is provided with sealing gaskets 121 to maintain the gas impermeability of the first compartment 131 and the second compartment 132. The gas outlet 112 is provided with a duct 1121, on which at least one venting nozzle 1122 is provided. The number of the venting nozzles may be adjusted as required, and the number of the ignition devices may be adjusted accordingly. A flow check valve 15 is fixed on the duct 1121 to control the flow rate of the thermal runaway fume. The first compartment 131 and/or the second compartment 132 are(is) provided with an elastic assembly 14, which abuts between the first compartment 131 and/or the second compartment 132 and the movable partition 17. The gas storage chamber 11 comprises a mounting part 16 for fixedly mounting on the battery cells. The ignition device 12 is a pulse igniter, and is fixed to the gas storage chamber via a supporting base 18. The movable partition 17 is provided with a stabilizing base 171 for stabilizing the movement of the movable partition 17.

### Embodiment 8

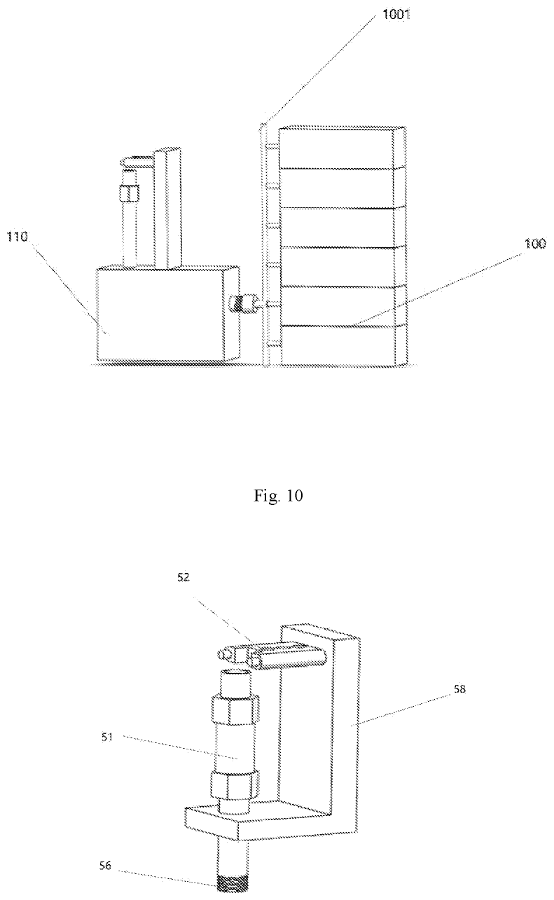

As shown in FIG. 10, a battery cell shell is provided, comprising the battery cell thermal runaway fume treatment device 110 provided by the embodiment 7. The battery cell shell 110 is connected with a manifold 1001 via an explosion vent, a plurality of battery cells are connected in shunt, and the manifold 1001 is connected to the thermal runaway fume treatment device 110 via the mounting part 16 of the thermal runaway fume treatment device. In the case that thermal runaway happens in any of the battery cells in the battery and thermal runaway fume is generated, the thermal runaway fume is discharged through the manifold to the thermal runaway fume treatment device for treatment. The device has a simple, safe and compact structure, is environment-friendly and highly efficient.

### Embodiment 9

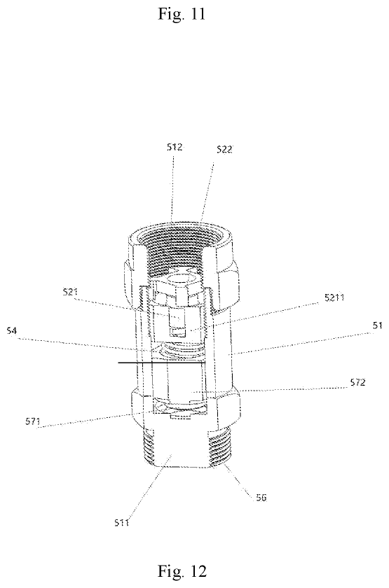

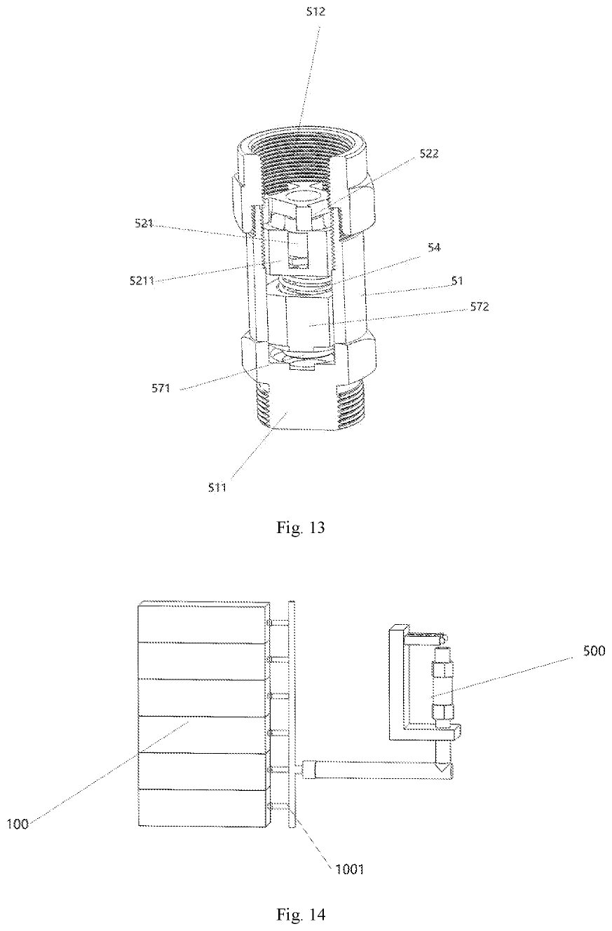

FIGS. 11-13 show schematic structural diagrams of the battery cell thermal runaway fume treatment device. The gas storage chamber 51 is a cylinder, and is divided by a movable partition 57 into a first compartment and a second compartment that are separated from each other.

The gas inlet 511 is arranged inside the first compartment, and the gas outlet 512 is arranged inside the second compartment.

An ignition switch 521 is provided inside the second compartment; when the gas pressure in the first compartment increases, the movable partition 57 is pushed by the gas pressure in the first compartment and touches the ignition switch 521, so that the ignition device 52 is switched on, and a gas discharge passage is formed between the gas outlet 512 and the gas inlet 511 to discharge the thermal runaway fume.

The first compartment is provided with an elastic assembly 54 fixedly arranged on the movable partition 57 for restricting the movable partition 57 from actuated at a lower gas pressure. The first compartment and/or the second compartment are(is) provided with an elastic assembly 541, which abuts between the first compartment and/or the second compartment and the movable partition 57. The gas storage chamber 51 comprises a mounting part 56 for fixedly mounting on the battery cells. The ignition device 52 is a pulse igniter, and is fixed to the gas storage chamber 51 via a supporting base 58. The movable partition 57 has a base 571 and a protrusion 572, wherein the protrusion 572 can be inserted into the gas inlet 511 to keep the gas inlet 511 in a hermetically closed state at normal pressure, and the protrusion 572 has sealing gaskets to keep the gas impermeability of the first compartment and the second compartment. The base 571 is movable along the cylinder axially, and there is a gap between the base 571 and the cylinder. In this embodiment, the base is square; alternatively, the base may be hexagonal, octagonal, or triangular, as long as a gap is produced between the base and the cylinder so that the thermal runaway fume can pass; an ignition switch 521 is provided on the base 571, and the ignition switch 521 has a mounting base 5211, an elastic assembly 54 is provided between the mounting base 5211 and the base 571, and a trigger block 522 is provided near the gas outlet 512 in the cylinder. The ignition switch 521 and the trigger block 522 are collectively referred to as a switch assembly, and the positions of the ignition switch and the trigger block can be adjusted as required. In this embodiment, the positions of the ignition switch and the trigger block may be swapped, as long as the purpose of switching on the ignition device can be attained.

When the thermal runaway fume passes through the gas inlet 511, the protrusion 571 is jacked up owing to the pressure increase, the gas inlet 511 is opened, and the thermal runaway fume reaches the gas outlet 512 through the cylinder, while the elastic assembly 54 is compressed, the ignition switch 521 is moved upward by the mounting base 5211 and then abutted by the trigger block 522, so that the ignition device 52 is switched on, and the thermal runaway fume is ignited at the gas outlet 512. The gas storage chamber 51 further has a supporting base 58 for fixing the ignition device 52 to the gas storage chamber 51.

The device is compact, easy to install, convenient to use, and has a low cost but high efficiency.

### Embodiment 10

As shown in FIG. 14, a battery cell shell 100 is provided, comprising the battery cell thermal runaway fume treatment device 500 provided by the embodiment 9. The battery cell shell is connected with a manifold 1001 via an explosion vent, a plurality of battery cells are connected in shunt, and the manifold 1001 is connected to the thermal runaway fume treatment device 500 via the mounting part 56 of the thermal runaway fume treatment device 500. In the case that thermal runaway happens in any of the battery cells in the battery and thermal runaway fume is generated, the thermal runaway fume is discharged through the manifold to the thermal runaway fume treatment device for treatment. The device has a simple, safe and compact structure, is environment-friendly and highly efficient.

### Embodiment 11

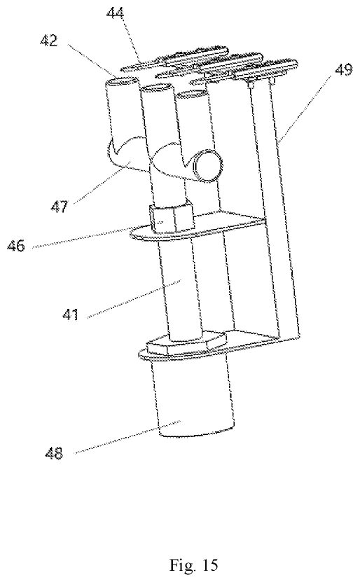

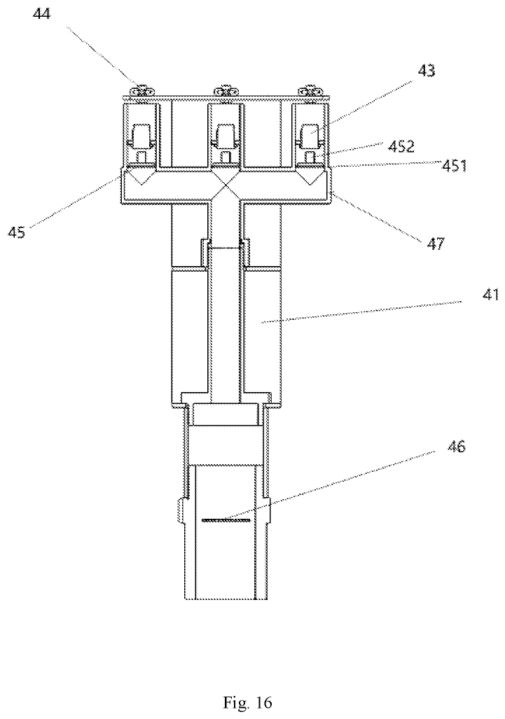

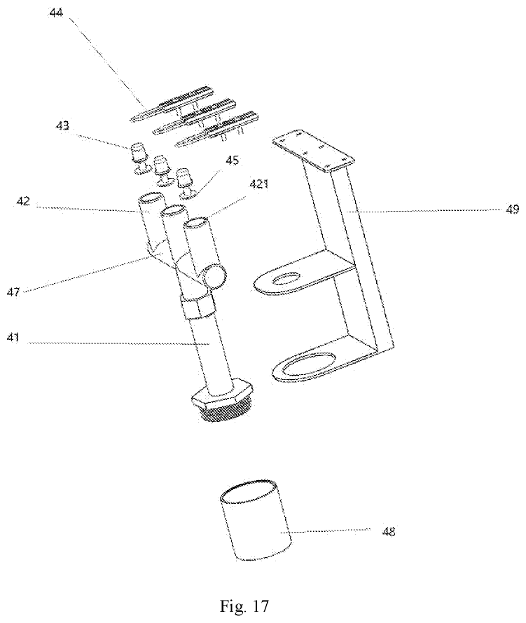

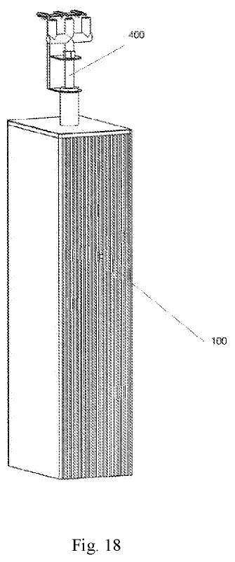

As shown in FIGS. 15-17, a battery cell thermal runaway fume treatment device 400 is provided, comprising a venting cylinder 41, a plurality of venting nozzles 42, ignition switches 43, ignition devices 44, and pressure valves 45, wherein the venting nozzles 42 are fixedly connected to the venting cylinder 41 respectively to form venting passages for the thermal runaway fume.

The pressure valves 45 and the ignition switches 43 are arranged in the venting passages. The pressure valve 45 seals the corresponding venting passage at normal pressure to keep the venting passage closed; at a high pressure, the piston in the pressure valve 5 is pushed by the gas pressure to move, and the venting passage is opened, and the pressure valve 45 abuts against the ignition switch 43, so that the ignition device 44 is switched on.

When a battery cell generates thermal runaway fume, the pistons in the pressure valves 45 are pushed in turn as the gas pressure increases gradually, the ignition switches 43 are actuated sequentially and switch on the ignition devices 44, so that the thermal runaway fume is ignited. The venting cylinder 41 is further provided with an anti-backfire valve therein. The pressure valve 45 is provided a sealing gasket 451. The venting cylinder 41 and the venting nozzles 42 are fixedly arranged on the fixing cylinders 47 respectively to form gas passages, so that the thermal runaway fume can pass through the venting cylinder 41, the fixing cylinders 47, and the venting nozzles 42 sequentially.

The pressure valve 45 is fixedly arranged at a joint between the fixing cylinder 47 and the venting nozzle 42, the pressure valve 45 is provided with a protrusion 452, the ignition switch 43 is arranged inside the venting nozzle 42; when the piston of the pressure valve 45 is moved, the protrusion 452 abuts against the ignition switch 43, so that the ignition device 44 is switched on. The ignition device 44 is a pulse igniter. The ignition device 44 is fixedly mounted on the venting cylinder 41 via a supporting base 49.

The fume treatment device further comprises a mounting part 48 to mount on the battery cell shell.

### Embodiment 12

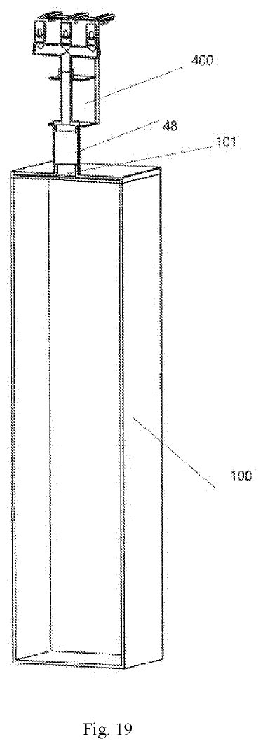

As shown in FIGS. 18-19, a battery cell shell 100 is provided, comprising the battery cell thermal runaway fume treatment device 400 provided by the embodiment 11. A mounting part 48 of the fume treatment device 400 is connected to the battery cell shell via an explosion vent 101. If there are a large number of battery cells, the plurality of battery cells are connected in shunt via the manifold, and the manifold is connected to the thermal runaway fume treatment device via the mounting part of the thermal runaway fume treatment device. In the case that thermal runaway happens in any of the battery cells in the battery and thermal runaway fume is generated, the thermal runaway fume is discharged through the manifold to the thermal runaway fume treatment device for treatment. The device has a simple, safe and compact structure, is environment-friendly and highly efficient.

### Embodiment 13

As shown in FIGS. 15-19, a battery cell thermal runaway fume treatment device 400 is provided, comprising a venting cylinder 41, a plurality of venting nozzles 42, ignition switches 43, ignition devices 44, and pressure valves 45, wherein the venting nozzles 42 are fixedly connected to the venting cylinder 41 respectively to form venting passages for the thermal runaway fume.

The pressure valves 45 and the ignition switches 43 are arranged in the venting passages. The pressure valve 445 seals the corresponding venting passage at normal pressure to keep the venting passage closed; at a high pressure, the piston in the pressure valve 5 is pushed by the gas pressure to move, and the venting passage is opened, and the pressure valve 45 abuts against the ignition switch 43, so that the ignition device 44 is switched on.

When a battery cell generates thermal runaway fume, the pistons in the pressure valves 45 are pushed in turn as the gas pressure increases gradually, the ignition switches 43 are actuated sequentially and switch on the ignition devices 44, so that the thermal runaway fume is ignited. The venting cylinder 41 is further provided with an anti-backfire valve 46 therein. The pressure valve 45 is provided a sealing gasket 451. The venting cylinder 41 and the venting nozzles 42 are fixedly arranged on the fixing cylinders 47 respectively to form gas passages, so that the thermal runaway fume can pass through the venting cylinder 41, the fixing cylinders 47, and the venting nozzles 42 sequentially.

The pressure valve 45 is fixedly arranged at a joint between the fixing cylinder 47 and the venting nozzle 42, the pressure valve 45 is provided with a protrusion 452, the ignition switch 43 is arranged inside the venting nozzle 42; when the piston of the pressure valve 45 is moved, the protrusion 452 abuts against the ignition switch 43, so that the ignition device 44 is switched on. The ignition device 44 is a pulse igniter. The ignition device 44 is fixedly mounted on the venting cylinder 41 via a supporting base 49.

The fume treatment device further comprises a mounting part 48 to mount on the battery cell shell.

### Embodiment 14

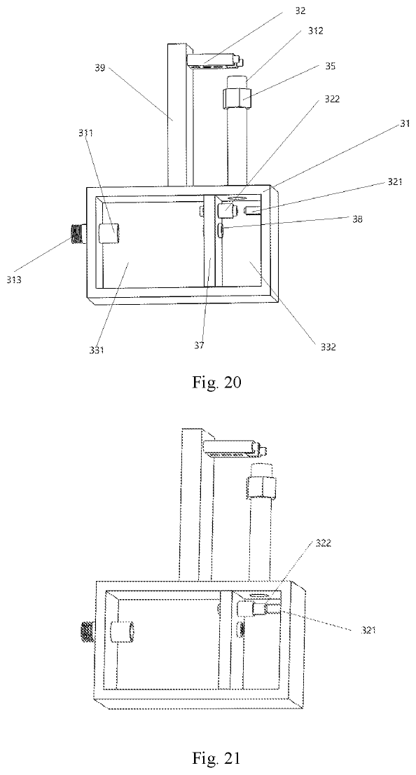

As shown in FIGS. 20-21, a battery cell thermal runaway fume treatment device is provided, comprising a gas storage chamber 31 and an ignition device 32, wherein the gas storage chamber 31 comprises a gas inlet 311 and a gas outlet 312 to introduce the thermal runaway fume into the gas storage chamber 31 and discharge the thermal runaway fume from the gas storage chamber 31; the ignition device 32 is fixedly arranged outside the gas storage chamber 31 at the gas outlet 312 for igniting the thermal runaway fume.

The gas storage chamber 31 is partitioned by a movable partition 37 into a first compartment 331 and a second compartment 332 that are separated from each other. The gas inlet 311 is arranged inside the first compartment 331, and the gas outlet 312 is arranged inside the second compartment 332.

A switch assembly is further provided in the gas storage chamber 31, and comprises an ignition switch 321 fixed in the second compartment 332 and a trigger 322 that is arranged on the partition 37 and penetrates through the partition 37. The ignition switch 321 can be actuated by the trigger 322 by means of abutment to switch on the ignition device.

The partition 37 is further provided with a pressure-relief valve 38, and the thermal runaway gas can pass through the pressure-relief valve 38 and enter the second compartment 312 from the first compartment 311.

When the gas pressure in the first compartment 331 increases and reaches a first threshold P₁, the thermal runaway gas enters the second compartment 332 through the pressure-relief valve 38, and reaches the outlet through the gas outlet 312; when the gas pressure in the first compartment 331 increases and reaches a second threshold P₂, the trigger 322 abuts against the ignition switch 321, so that the ignition switch 321 switches on the ignition device 32 to ignite the thermal runaway fume. In this embodiment, the first threshold P₁ is not smaller than the second threshold P₂, to prevent the thermal runaway fume from discharged out of the gas storage chamber 31 through the pressure-relief valve 38 before the trigger 322 abuts against the ignition switch 321 and the ignition device 32 is switched on, which may result in air pollution or vent hazards.

When the trigger 322 that penetrates through the partition 37 is pushed by the gas pressure in the first compartment 331, it touches the ignition switch 321, so that the ignition device 32 is switched on, and the gas outlet 312 is at least partially exposed to the first compartment 331 to discharge the thermal runaway fume.

In this embodiment, the gas outlet 312 may be configured as a duct, on which a flow check valve 35 is fixed to control the flow rate of the thermal runaway fume and prevent backfire. The gas outlet 312 may be provided with at least two venting nozzles. A plurality of venting nozzles can achieve an effect of homogenizing the pressure for efficient ignition; then, a plurality of ignition ports may be provided in correspondence to the plurality of venting nozzles; the number of the venting nozzles may be the same as or different from the number of the ignition ports; the plurality of ignition ports can efficiently ignite the thermal runaway fume discharged from the plurality of gas outlets. The gas storage chamber 31 has a supporting part 39 for fixedly mounting the ignition devices 32. In this embodiment, the ignition devices 32 are pulse igniters.

### Embodiment 15

A battery cell shell is provided, comprising the battery cell thermal runaway fume treatment device as shown in FIGS. 20-21, which comprises a gas storage chamber 31 and an ignition device 32, wherein the gas storage chamber 31 comprises a gas inlet 311 and a gas outlet 312 for introducing thermal runaway fume into the gas storage chamber 31 and discharging thermal runaway fume out of the gas storage chamber 31; the ignition device 32 is fixedly arranged outside the gas storage chamber 31 at the gas outlet 312 for igniting the thermal runaway fume.

The gas storage chamber 31 is partitioned by a movable partition 37 into a first compartment 331 and a second compartment 332 that are separated from each other.

The gas inlet 311 is arranged inside the first compartment 331, and the gas outlet 312 is arranged inside the second compartment 332.

A switch assembly is further provided in the gas storage chamber 31, and comprises an ignition switch 321 fixed in the second compartment 332 and a trigger 322 that is arranged on the partition 37 and penetrates through the partition 37. The ignition switch 321 can be actuated by the trigger 322 by means of abutment to switch on the ignition device.

The partition 37 is further provided with a pressure-relief valve 38, and the thermal runaway gas can pass through the pressure-relief valve 38 and enter the second compartment 312 from the first compartment 311.

When the gas pressure in the first compartment 331 increases and reaches a first threshold P₁, the thermal runaway gas enters the second compartment 332 through the pressure-relief valve 38, and reaches the outlet through the gas outlet 312; when the gas pressure in the first compartment 331 increases and reaches a second threshold P₂, the trigger 322 abuts against the ignition switch 321, so that the ignition switch 321 switches on the ignition device 32 to ignite the thermal runaway fume. In this embodiment, the first threshold P₁ is not smaller than the second threshold P₂, to prevent the thermal runaway fume from discharged out of the gas storage chamber 31 through the pressure-relief valve 38 before the trigger 322 abuts against the ignition switch 321 and the ignition device 32 is switched on, which may result in air pollution or vent hazards.

When the trigger 322 that penetrates through the partition 37 is pushed by the gas pressure in the first compartment 331, it touches the ignition switch 321, so that the ignition device 32 is switched on, and the gas outlet 112 is at least partially exposed to the first compartment 131 to discharge the thermal runaway fume.

In this embodiment, the gas outlet 312 may be configured as a duct, on which a flow check valve 35 is fixed to control the flow rate of the thermal runaway fume and prevent backfire. The gas outlet 312 may be provided with at least two venting nozzles. A plurality of venting nozzles can achieve an effect of homogenizing the pressure for efficient ignition; then, a plurality of ignition ports may be provided in correspondence to the plurality of venting nozzles; the number of the venting nozzles may be the same as or different from the number of the ignition ports; the plurality of ignition ports can efficiently ignite the thermal runaway fume discharged from the plurality of gas outlets. The gas storage chamber 31 has a supporting part 39 for fixedly mounting the ignition devices 32. In this embodiment, the ignition devices 32 are pulse igniters.

In this embodiment, the gas inlet 311 extends radially out of the gas storage chamber 31 and is provided with a mounting part 313, which as male threads and is fixedly connected to the explosion vent of the battery cell shell.

### Embodiment 16

In this embodiment, a battery cell is provided, comprising a battery core, an electrode assembly, and the battery cell shell according to the embodiment 15.

### Embodiment 17

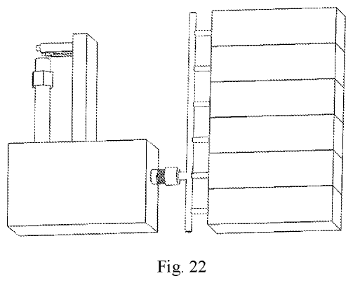

As shown in FIG. 22, in this embodiment, a battery is provided, comprising a plurality of battery cells according to the embodiment 19, and a manifold, wherein one end of the manifold comprises a plurality of branch ducts that are connected to the explosion vent in one-to-one correspondence, and the other end of the manifold is fixedly connected to the mounting part of the thermal runaway fume treatment device. In the case of thermal runaway in the battery, the thermal runaway fume can be transferred through the manifold to the fume treatment device.

The above disclosure of the present application is not intended to describe every and all embodiments or implementations in the present application. Exemplary embodiments are illustrated more specifically below. Throughout the present application, teaching is provided by means of a series of embodiments, which can be used in various combinations. In the examples, the enumerations are only intended to present representative groups, and shall not be interpreted as being exhaustive.

1. A Li-ion battery, comprising:
at least one battery cell;
an explosion-venting mechanism fixed to the battery cell for releasing thermal runaway fume generated by the battery cell in the case of thermal runaway;
a manifold fixedly connected to the explosion-venting mechanism for transferring the thermal runaway fume; and
an ignition device fixedly connected to the manifold to ignite the thermal runaway fume transferred from the manifold.

2. The Li-ion battery according to claim 1, wherein the manifold is further provided with a backfire preventer fixed thereon.

3. The Li-ion battery according to claim 1, wherein the Li-ion battery cell further comprises a buffer device arranged in front of the ignition device.

4. The Li-ion battery according to claim 3, wherein the buffer mechanism is provided with a pressure-relief valve.

5. The Li-ion battery according to claim 3, wherein the buffer mechanism is an elastic bag or pressure container.

6. The Li-ion battery according to claim 1, wherein the ignition device is a pulse igniter; and the ignition device further comprises an air inlet for introducing air to mix with the thermal runaway fume for ignition.

7. A Li-ion battery pack, comprising:
a box, inside which a plurality of Li-ion battery cells are arranged;
an explosion-venting mechanism fixed to the box for releasing thermal runaway fume generated by the battery cells in the case of thermal runaway;
a manifold fixedly connected to the explosion-venting mechanism for transferring the thermal runaway fume; and
an ignition device fixedly connected to the manifold to ignite the thermal runaway fume transferred from the manifold.

8. The Li-ion battery pack according to claim 7, wherein the manifold is further provided with a backfire preventer fixed thereon.

9. The Li-ion battery pack according to claim 7, wherein the Li-ion battery cell further comprises a buffer device arranged in front of the ignition device; and the buffer mechanism is further provided with a pressure-relief valve.

10. The Li-ion battery pack according to claim 7, wherein the buffer mechanism is an elastic bag or pressure container.

11. The Li-ion battery pack according to claim 7, wherein the ignition device is a pulse igniter; and the ignition device further comprises an air inlet for introducing air to mix with the thermal runaway fume for ignition.

12. A battery cell thermal runaway fume treatment device, comprising a gas storage chamber and an ignition device, wherein
the gas storage chamber comprises a gas inlet and a gas outlet for introducing the thermal runaway fume into the gas storage chamber and discharging the thermal runaway fume out of the gas storage chamber;
the ignition device is fixedly arranged outside the gas storage chamber at the gas outlet;
the gas storage chamber is partitioned by a movable partition into a first compartment and a second compartment that are separated from each other;
the gas inlet is arranged inside the first compartment, and the gas outlet is arranged inside the second compartment;
the second compartment is further provided with a switch assembly therein, which comprises an ignition switch; and
when the gas pressure in the first compartment increases, the movable partition is pushed by the gas pressure in the first compartment to abut against the ignition switch, so that the ignition device is switched on and the gas outlet is at least partially exposed to the first compartment to discharge the thermal runaway fume.

13. The battery cell thermal runaway fume treatment device according to claim 12, wherein
the first compartment is provided with an elastic assembly, the elastic assembly abuts between the first compartment and the movable partition; and/or
the second compartment is provided with the elastic assembly, the elastic assembly abuts between the second compartment and the movable partition.

14. The battery cell thermal runaway fume treatment device according to claim 12, wherein the movable partition is provided with sealing gaskets to maintain the gas impermeability of the first compartment and the second compartment.

15. The battery cell thermal runaway fume treatment device according to claim 12, wherein the gas outlet is configured as a duct, on which a flow check valve is provided to control the flow rate of the thermal runaway fume.

16. The battery cell thermal runaway fume treatment device according to claim 13, wherein the gas storage chamber comprises a mounting part for fixedly mounting on the battery cells.

17. The battery cell thermal runaway fume treatment device according to claim 12, wherein the ignition device is a pulse igniter.

18. The battery cell thermal runaway fume treatment device according to claim 12, wherein the gas storage chamber is a cylinder, the movable partition comprises a base and a protrusion, wherein the protrusion can be inserted into the gas inlet to maintain the gas inlet in a hermetical state at normal temperature, the base is movable along the cylinder axially, and there is a gap between the base and the cylinder for the thermal runaway fume to pass through; the base is further provided with the switch assembly, the protrusion is jacked up and the switch assembly is abutted when the thermal runaway fume passes through the gas inlet owing to pressure increase, so that the ignition device is switched on and the thermal runaway fume is ignited.

19. A battery cell shell, comprising the battery cell thermal runaway fume treatment device according to claim 14.

20. The battery cell shell according to claim 19, further comprising a manifold, wherein one end of which is connected to an explosion vent of the battery cell shell, and the other end of which is fixedly connected to the mounting part of the thermal runaway fume treatment device.

21. A battery cell thermal runaway fume treatment device, comprising a venting cylinder, a plurality of venting nozzles, pressure valves, ignition switches, and ignition devices, wherein
the venting nozzles are fixedly connected to the venting cylinder respectively to form thermal runaway fume venting passages;
the pressure valves and the ignition switches are arranged inside corresponding venting passages, each of the pressure valves comprises a piston, and seals the corresponding venting passage at normal pressure to keep the venting passage closed; at a high pressure, the piston inside the pressure valve is pushed by the gas pressure to move, so that the venting passage is opened, and the pressure valve abuts against the ignition switch to switch on the ignition device at the same time; and
when a battery cell generates thermal runaway fume, the pistons in the pressure valves are pushed in turn as the gas pressure increases gradually, the ignition switches are actuated sequentially and switch on the ignition devices, so that the thermal runaway fume is ignited.

22. The battery cell thermal runaway fume treatment device according to claim 21, wherein the venting cylinder is further provided with an anti-backfire valve.

23. The battery cell thermal runaway fume treatment device according to claim 21, wherein the pressure valve is provided with a sealing gasket.

24. The battery cell thermal runaway fume treatment device according to claim 21, wherein the venting cylinder and the venting nozzles are fixedly arranged on the fixing cylinders respectively to form gas passages, so that the thermal runaway fume can pass through the venting cylinder, the fixing cylinders, and the venting nozzles sequentially.

25. The battery cell thermal runaway fume treatment device according to claim 24, wherein the pressure valve is fixedly arranged at a joint between the fixing cylinder and the venting nozzle, the pressure valve is provided with a protrusion, the ignition switch is arranged inside the venting nozzle; when the piston of the pressure valve is moved, the protrusion abuts against the ignition switch, so that the ignition device is switched on.

26. The battery cell thermal runaway fume treatment device according to claim 21, wherein the ignition device is a pulse igniter.

27. The battery cell thermal runaway fume treatment device according to claim 21, wherein the fume treatment device further comprises a mounting part to mount on the battery cell shell.

28. A battery cell thermal runaway gas treatment device, comprising a gas storage chamber, wherein
the gas storage chamber is provided with a sealing partition therein to separate the gas storage chamber into an enclosed first compartment and an enclosed second compartment;
the first compartment comprises a gas inlet duct for the thermal runaway gas to enter the first compartment;
the second compartment comprises a venting duct to discharge the thermal runaway gas, and the ignition device is arranged at an outlet of the venting duct;
the partition is provided with a pressure-relief valve, and the thermal runaway gas can pass through the pressure-relief valve and enter the second compartment from the first compartment;
the gas storage chamber is further provided with a switch assembly, which comprises a trigger and an ignition switch, wherein the trigger is inserted through the partition and can be pushed by the gas pressure, and the ignition switch is arranged inside the second compartment and can be actuated by the trigger;
when the gas pressure in the first compartment reaches a first threshold P₁, the thermal runaway gas enters the second compartment through the pressure-relief valve, and reaches the outlet through the venting duct;
when the gas pressure in the first compartment reaches a second threshold P₂, the trigger abuts against the ignition switch, so that the ignition switch is actuated and switches on the ignition device, and the thermal runaway gas is ignited; and
the value of the first threshold P₁ is not smaller than the value of the second threshold P₂.

29. The battery cell thermal runaway fume treatment device according to claim 28, wherein the partition is provided with sealing gaskets to maintain the gas impermeability of the first compartment and the second compartment.

30. The battery cell thermal runaway fume treatment device according to claim 28, wherein the gas outlet duct is provided with a flow check valve to control the flow rate of the thermal runaway fume.

31. The battery cell thermal runaway fume treatment device according to claim 28, wherein the ignition device is a pulse igniter.

32. The battery cell thermal runaway fume treatment device according to claim 28, wherein the gas outlet is provided with at least two venting nozzles, and the ignition device comprises at least two ignition ports.

33. The battery cell thermal runaway fume treatment device according to claim 28, wherein the gas storage chamber is provided with a supporting base outside it for mounting the ignition device.

34. A battery cell shell, comprising an explosion vent thereon and the battery cell thermal runaway fume treatment device according to claim 28, wherein the gas inlet of the battery cell thermal runaway fume treatment device is provided with a mounting part for fixedly mounting to the explosion vent.

35. A battery cell, comprising the battery cell shell according to claim 34.
